(19) United States
(12) Patent Application Publication
(10) Pub. No.: US 2010/0219668 A1
(43) Pub. Date: Sep. 2, 2010

(54) Devices and Methods for Lift Assistance

(75) Inventors: Jeffrey C. Nelson, Chicago, IL (US); Gregory C. Kilgore, Aurora, IL (US)

Correspondence Address: MOAZZAM & ASSOCIATES, LLC, 7601 LEWINSVILLE ROAD, SUITE 304, MCLEAN, VA, 22102, US

(73) Assignee: LIFTSEAT CORPORATION, Lombard, IL (US)

(21) Appl. No.: 12/784,263

(22) Filed: May 20, 2010

Related U.S. Application Data
(63) Continuation-in-part of application No. 11/747,160, filed on May 10, 2007.
(60) Provisional application No. 61/180,733, filed on May 22, 2009.
(60) Provisional application No. 60/799,660, filed on May 12, 2006.
(60) Provisional application No. 60/831,217, filed on Jul. 17, 2006.

(51) Int. Cl. A47C 1/00; A61G 5/14; A47K 11/04

(52) U.S. Cl. 297/330; 280/650; 4/479

(57) ABSTRACT

Devices and methods are disclosed which relate to lifting a user from a seated position to a raised position. This is performed by incorporating a lifting mechanism into a seat coupled to a movable base portion. Actuators coupled to drive shafts enable a plurality of linkages to be raised and tilted, enabling the seat to rise at the push of a button or other triggering mechanism. A plurality of compressible springs enables an even balance between the weight of the human and the pressure of the lifting mechanism underneath the seat. As the lifting portion lifts the seat, an angle of the seat changes from a substantially horizontal position to a relatively angled position, mimicking the natural motion of the hips and thighs for humans needing assistance. Embodiments disclosed include using the device as a bedside toilet, having a removable bowl attached to the seat, or using the device placed over a toilet.

This U.S. Utility Patent Application claims priority to U.S. Provisional Patent Application Ser. No. 61/180,733, filed May 22, 2009; and is a continuation-in-part (CIP) of U.S. patent application Ser. No. 11/747,160, filed May 10, 2007; which claims priority to U.S. Provisional Patent Application Ser. No. 60/799,660, filed May 12, 2006; and to U.S. Provisional Patent Application Ser. No. 60/831,217, filed Jul. 17, 2006, the contents of all of which are hereby incorporated by reference in their entirety into this disclosure.

### BACKGROUND OF THE INVENTION

1. Field of the Invention

The present invention relates to techniques for lifting. In particular, the present invention relates to devices and methods for lifting humans from a seated position to a raised position and vice versa.

2. Background of the Invention

The process of sitting or standing is one of the most common and routine movements for human beings. The human body is designed to be able to perform such movement with minimal effort. However, such movements, which are routine for most people, are not so routine for certain classes of people. For example, the elderly, the disabled, the obese, the pregnant, or the weak may have considerable difficulty standing or sitting. Other persons who typically have no problem with the movement of sitting or standing could also have temporary difficulty after surgery or injury. Thus, there are many situations where persons will have temporary or permanent difficulty with the routine process of sitting or standing.

Conventional devices exist in the market to assist with the movement required for sitting or standing. For example, standard crutches are typically used as an anchoring bar to hold and pull during the motion. However, a major drawback of using standard crutches is the need for considerable upper body strength to support a substantial portion of the body weight during the process of sitting or standing. Also, crutches tend to move with the shift of weight, and can often slip at the most crucial time, when the person using them is supporting all of his or her weight on the crutches. Such movement can result in injury to the person using these crutches.

Another conventional device is a standard walker, which is a simple U-shaped device typically having four wheels that allow a user to walk with and lean against the device during movement. Although a walker is really designed to aid in walking movement, it can also be used in the same manner as a crutch, i.e., as an anchor during the motion of standing or sitting. Although the walker is typically more stable than standard crutches because it is self-supporting, the walker can still topple over if enough force or pull is exerted to tip the device over during motion. The walker also needs considerable upper body strength on the part of the user. Thus, there is still some risk of injury to the person using the walker during such motion.

Finally, a few conventional devices have been made that assist a person in standing from a sitting position. However, these devices are typically not designed specifically for a toilet seat and have a one way axis of motion, resulting in a sudden jerk movement that could potentially cause harm or injury to an already weakened, fragile, or injured body, as well as require additional vertical motion which a user may not have the strength to provide.

Thus, there is a need in the art for a simple and universal device to assist in the lifting of humans, by raising and lowering the person gently in a natural and fluid manner. The device should be simple to use, efficient, safe and able to be installed in a relatively short period of time.

### SUMMARY OF THE INVENTION

The present invention solves the above problems by incorporating a lifting mechanism into a seat coupled to a movable base portion. As the lifting portion lifts the seat, an angle of the seat changes from a substantially horizontal position to a relatively angled position, mimicking the natural motion of the hips and thighs for humans needing assistance. Actuators coupled to drive shafts enable a plurality of linkages to be raised and tilted, enabling the seat to rise at the push of a button or other triggering mechanism. A plurality of compressible springs enables an even balance between the weight of the human and the pressure of the lifting mechanism underneath the seat. The device can be used as a bedside toilet, having a removable bowl attached to the seat, or placed over a toilet, and can accordingly be height-adjusted to fit most existing toilets.

In one exemplary embodiment, the present invention is a lift-assist device, comprising a horizontal base portion including a pair of base members extending from a rear end to a front end of the device, a substantially vertical support extending perpendicularly from a top surface of each base member, a drive shaft coupled to and placed in between each vertical support, a lifting mechanism including a pair of upper linkages and a pair of lower linkages, each linkage having a front end and a rear end, the front end of each pair of linkages being pivotally coupled to each substantially vertical support, the front end of the pair of lower linkages further being fixedly coupled to each end of the driveshaft, and a substantially planar seat portion including a pair of seat supports extending perpendicular to a bottom surface of the seat portion, each seat support being pivotally coupled to a rear end of each upper and a lower linkage, wherein a rotational movement about an horizontal axis of the driveshaft raises the rear end of the pair of lower linkages, thereby moving the seat portion from a sitting position to a raised position. The pair of upper linkages is pivotally coupled to each seat support at a point higher than a point where the pair of lower linkages pivotally couples to the seat support, such that the seated position of the seat portion is substantially horizontal with respect to the raised position. An actuator provides rotational energy to the driveshaft.

In another exemplary embodiment, the present invention is a human lifting device comprising a base portion, a pair of vertical supports fixedly coupled to a left and a right side of the base portion, a plurality of linkages pivotally coupled to each vertical support at a front end of the plurality of linkages, a seat portion having a pair of seat supports extending from a bottom surface of the seat portion, each seat support being pivotally coupled to a rear end of the plurality of linkages coupled to the corresponding vertical support, a plurality of compressible springs pivotally coupled to the base portion and the plurality of linkages, and a lifting mechanism comprising an actuator coupled to the base portion that, upon activation, lifts the seat portion from a seated position that is substantially planar to a raised position that is substantially angled relative to the seated position. The front ends of the plurality of linkages are coupled to different heights on the vertical support and on the seat support, so as to control the angle of the seat portion from the seated position to the raised position. A drive shaft is coupled to and placed in between each vertical support, said driveshaft being fixedly coupled to a front end of at least one of the plurality of linkages such that a rotational movement of the driveshaft moves the seated portion from a seated position to a raised position, wherein the actuator provides rotational energy to the driveshaft.

In yet another exemplary embodiment, the present invention is method for lifting a user from a substantially sitting position to a substantially standing position, the method including positioning the user in a substantially sitting position on a device having a planar seat portion, a lifting mechanism, and a base portion, mechanically driving the seat portion substantially upward at a comfortable pace, supporting the seat portion evenly via a plurality of extendible springs pivotally coupled to the base portion and the seat portion, maintaining, dynamically, the seat portion at a critical angle to provide even support to a weight of the user and a leaning force of the user as the seat is driven upward until the user reaches a substantially standing position, and mechanically lowering the seat portion following the critical angle until the user reaches a substantially sitting position. The maintaining step further comprises a first, lowered angle that is substantially planar and a second, lifted angle that is substantially horizontal, so as to counteract a leaning force of a user. The device may be placed over a toilet seat. A handlebar can be removed to enable a user to be transported from the device onto a bed and vice versa.

### BRIEF DESCRIPTION OF THE DRAWINGS

FIG. 1 shows a lift assist device, according to an exemplary embodiment of the present invention.

FIG. 2 shows a lift assist device in a partially lifted position, according to an exemplary embodiment of the present invention.

FIGS. 3A and 3B show a lifting mechanism of a lift assist device, according to an exemplary embodiment of the present invention.

FIGS. 4A and 4B show a lifting mechanism of a lift assist device, according to an exemplary embodiment of the present invention.

FIG. 5 shows a driveshaft of a lift assist device, according to an exemplary embodiment of the present invention.

FIG. 6 shows a wheel locking mechanism of a lift assist device, according to an exemplary embodiment of the present invention.

FIGS. 7A and 7B show controls for a lift assist device, according to an exemplary embodiment of the present invention.

FIGS. 8A-8C show a lift assist device for lifting a user over a toilet, according to an exemplary embodiment of the present invention.

FIGS. 9A and 9B show a lift assist device for transporting a user, according to an exemplary embodiment of the present invention.

FIG. 10 shows a toilet seat coupled to a seat portion of a lift assist device, according to an exemplary embodiment of the present invention.

FIGS. 11A-11C show a drop-in commode bucket for use with a lift assist device, according to an exemplary embodiment of the present invention.

FIG. 12 shows a method of lifting a user from a substantially sitting position to a substantially standing position, according to an exemplary embodiment of the present invention.

FIGS. 13A and 13B show the range of motion of a lift assist device, according to an exemplary embodiment of the present invention.

FIG. 14 shows a telescoping shroud for the linkages of a lift assist device, according to an exemplary embodiment of the present invention.

FIG. 15 shows a battery and control box location on a lift assist device, according to an exemplary embodiment of the present invention.

FIGS. 16A and 16B show views of a lift assist device having a back rest and adjustable rear stabilizer bar, according to an exemplary embodiment of the present invention.

FIG. 17 shows a bedside lift assist device with a contoured seat portion, according to an exemplary embodiment of the present invention.

FIG. 18 shows a height-adjustable over-the-toilet lift assist device with removable handlebars, according to an exemplary embodiment of the present invention.

### DETAILED DESCRIPTION OF THE INVENTION

The present invention presents a novel technique for lifting users from a seated position to a substantially standing position without suffering from some of the drawbacks of conventional devices. A lifting mechanism is coupled between a seat portion and a movable base portion. The lifting mechanism includes a pair of upper and lower linkages pivotally coupled to different points on vertical supports on the base portion and on seat supports on the seat portion. An actuator provides rotational energy to a drive shaft that is fixedly coupled to a front end of at least one of the linkages. As the drive shaft rotates, the linkages move in such a way so as to lift the seat while changing an angle of the seat from a substantially horizontal position (seated) to a relatively angled position (raised). A plurality of compressible springs enables an even balance between the weight of the human and the pressure of the lifting mechanism underneath the seat. Furthermore, the device also includes a housing or a “shroud” around moving components so as to avoid injury, as well as present an aesthetic face to a unique and advantageous lifting mechanism. Such cover also maintains the lifting mechanism in a relatively “clean” environment by acting as a shield for potential liquids or matter that may cause corrosion, rusting or other deterioration of the materials composing its parts.

It should be noted that one of many unique advantages of the present invention over conventional approaches is the natural movement that results from the disclosed lifting mechanism. Considering the natural motion of a person who is about to sit from a standing position, the lifting mechanism enables a lowering and moving backwards of the person with respect to the person's standing position. Thus, there is not only a relative vertical change in position but also a horizontal change in torso or “core” position, with the torso being supported from below (on a vertical axis), even while lowering, as well as from behind (on a horizontal axis). In studying such natural motion, the present invention is designed to mimic such motion to a degree that the device actually lowers and backs a user during the resting motion, and conversely, raises and pushes the user gently during the lifting process.

The present invention includes and improves upon the invention described in the prior filed application, U.S. Ser. No. 11/747,160, filed May 10, 2007, and incorporated by reference herein in its entirety. In the present application, various embodiments are being simultaneously presented which show additional variations of the prior filed application.

As used herein and throughout this disclosure, the term “lift” is defined as a relative change in elevation, such as a relative lifting or lowering or other movement of a portion of a body from one position to the next. Lifting is a movement from a lowered or seated position into a raised or standing position. The opposite of lifting is lowering, i.e., from a standing position to a seated position. However, the word lifting as used herein and throughout this disclosure should be construed to include both raising and lowering motions. As applied to the present invention, exemplary devices and methods assist in lifting a user, resulting in either a relative raising or relative lowering of the body or portion thereof from one position to the next.

For the following description, it can be assumed that most correspondingly labeled structures across the figures (e.g., 132, 232 and 332, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

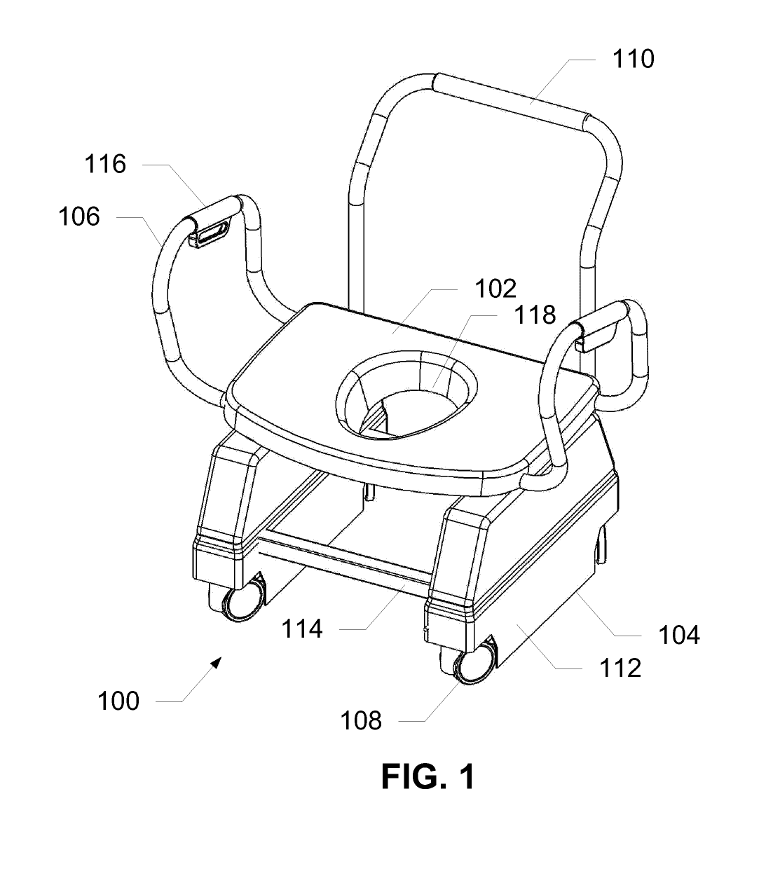

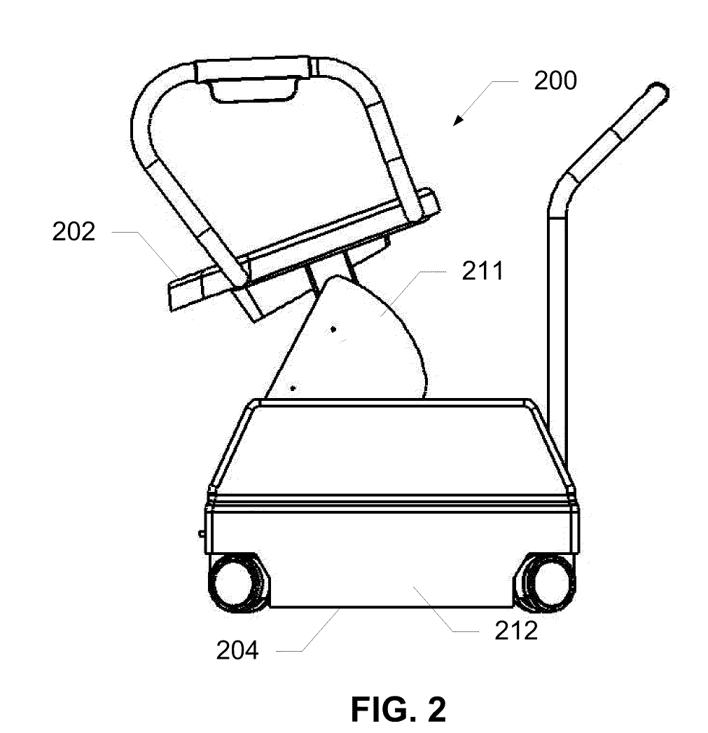

FIG. 1 shows a lift assist device 100, according to an exemplary embodiment of the present invention. In this embodiment, lift assist device 100 includes a seat portion 102, a base portion 104, handlebars 106 on the left and right sides of seat portion 102, a shroud 112 on both sides covering a lifting mechanism (not shown), a front stabilizing bar 114 surrounding a drive shaft (not shown), wheels 108, and a push bar 110. Lift assist device 100 lifts a user from a lowered, or seated, position, seen in FIG. 1, to a raised position, seen in FIG. 2, or vice versa. The user sits on seat portion 102 while lift assist device 100 is in the seated position. In this position, an assistant may roll the user on lift assist device 100 around an area using push bar 110. The user may hold onto handlebars 106 for support while being moved, and also when sitting onto or leaving lift assist device 100. Handlebars 106 may include controls 116. Controls 116, located on handlebars 106 or elsewhere on lift assist device 100, allow the user, or an assistant, to raise or lower seat portion 102. For instance, when the user desires to stand up, the user controls lift assist device 100 to raise, moving seat portion 102 from the substantially horizontal plane seen in the seated position, to the substantially angled plane, seen in the raised position. From the raised position, the user may easily stand up. The final angle of seat portion 102 may, but does not have to, be substantially vertical, as some users may not necessarily need a complete vertical position of the seat portion to be able to stand up after such a lifting motion. Upon reading this disclosure, it will be recognized by one of ordinary skill in the art, that adjustments can be made as to a maximum height of the seat, and presets can be programmed into controls 116 for different users.

Seat portion 102 is constructed of a substantially rigid material, such as metal or plastic. Seat portion 102 includes a hole 118, such that lift assist device 100 may be placed and used above a toilet. Hole 118 can include a splash guard (not shown) for male patients to guide urine downwards and into the toilet. Seat portion 102 may further include a cushioning material to provide comfort to the user. Seat portion 102 may be made out of a material that is naturally anti-microbial, or treated with an anti-microbial treatment. Handlebars 106 and push bar 110 are also constructed of a substantially rigid material. Handlebars 106 must be able to withstand a portion of the user's weight pushing or pulling on handlebars 106 from various angles. As shown in FIG. 1, handlebars 106 extend from a rear end to a front end of both sides of seat portion 102 in a horizontal direction and bend to a vertical direction. However, any other alignment of handlebars 106 is also possible. Further, handlebars 106 are removable on one or both sides to enable a human to enter lift assist device 100 from one side, for instance, from a hospital bed.

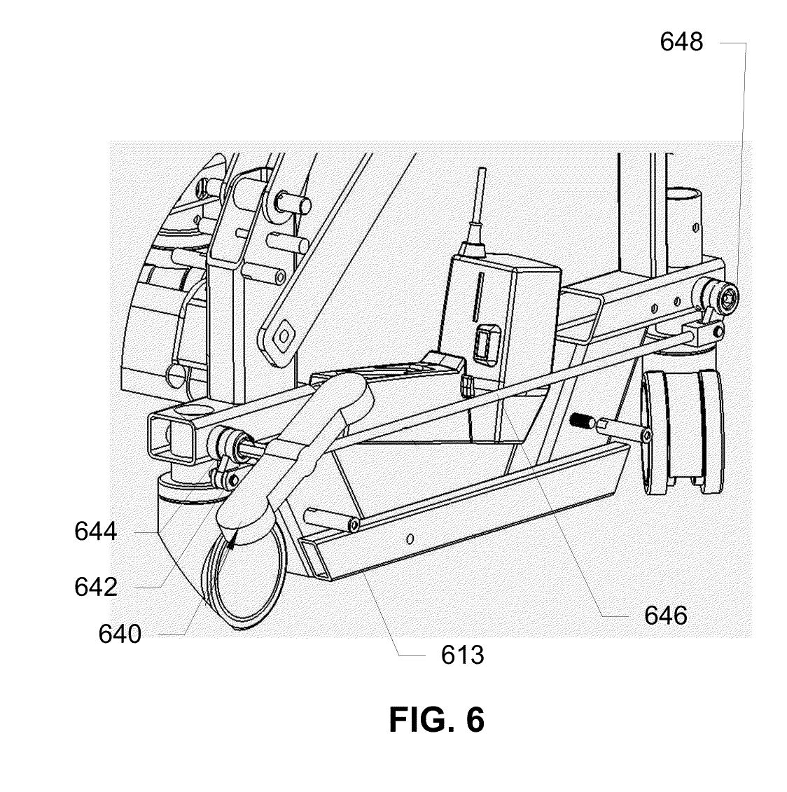

Push bar 110 extends from a rear end of base portion 104 and bends outwards behind seat portion 102. This allows for the assistant to push or pull lift assist device 100 from behind. Any other alignment or placement of push bar 110 is also possible, depending on desired pushing or pulling directions, design of other features of lift assist device 100, etc. Further, push bar 110 is adjustable or removable to allow lift assist device 100 to be placed in front of or directly above a toilet. Wheels 108 allow lift assist device 100 to be rolled around an area. Wheels 108 may be constructed of any material, such that wheels 108 allow for such rolling. For example, wheels 108 may include a rubber tire around a metal or plastic hub and rim, the hub rotatable around an axle. Wheels 108 may include a locking mechanism to prevent rolling at certain times, shown in FIG. 6.

Front stabilizing bar 114 provides stability and structure for lift assist device 100. Front stabilizing bar 114 connects a front end of the left portion of base portion 104 to a front end of the right portion of base portion 104. Front stabilizing bar 114 is constructed of a substantially rigid material such as metal or plastic. Shroud 112 covers the lifting mechanism, preventing the lifting mechanism from causing injury and keeping the lifting mechanism clean. Shroud 112 may be made of any material such that it serves this purpose. As seat portion 102 is lifted from the lowered position to the raised position, shroud 112 ensures the lifting mechanism is substantially covered. In embodiments of the present invention, shroud 112 comprises telescoping portions which extend as seat portion 102 is raised.

FIG. 2 shows a lift assist device 200 in a partially lifted position, according to an exemplary embodiment of the present invention. In this embodiment, a secondary shroud 211 is seen extending from shroud 212 to cover the lifting mechanism in this partially lifted state. In the partially lifted state, seat portion 202 is being raised above base portion 204. Seat portion 202 is at an angle in this partially lifted position. The angle enables a user to not only be lifted upwards, but also forward, thereby moving the user's center of gravity from the seated position to a position more centrally located over the legs, mimicking a natural standing motion.

In one exemplary embodiment, the linkages are sized and coupled in a way that enables the seat portion to rise approximately 9 inches vertically, and moved forward approximately 5 inches, with an angle of approximately 20 degrees away from the horizontal when in a fully raised position. Dimensions are approximate at the seated position of a persons buttocks

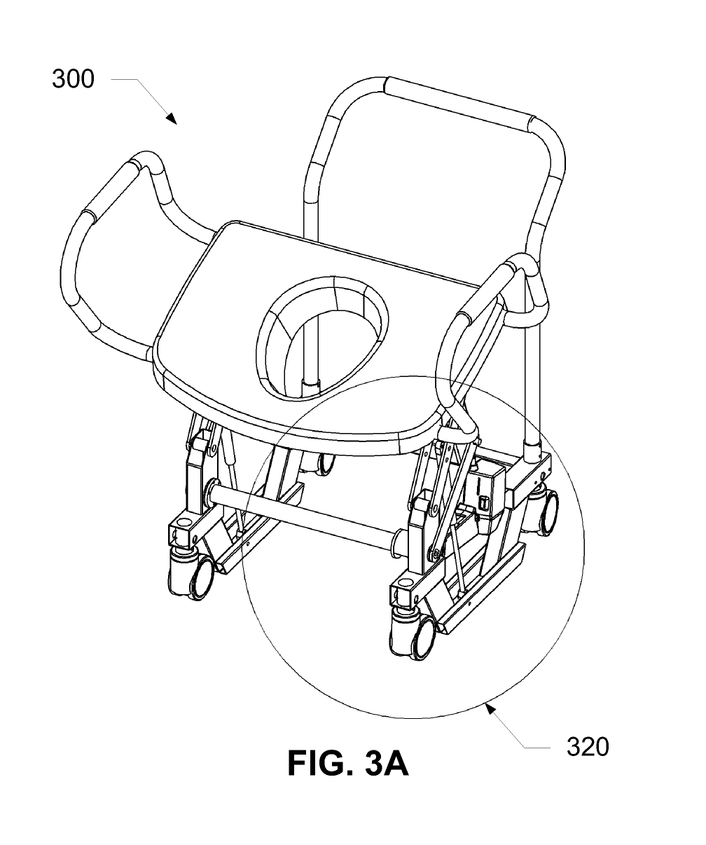

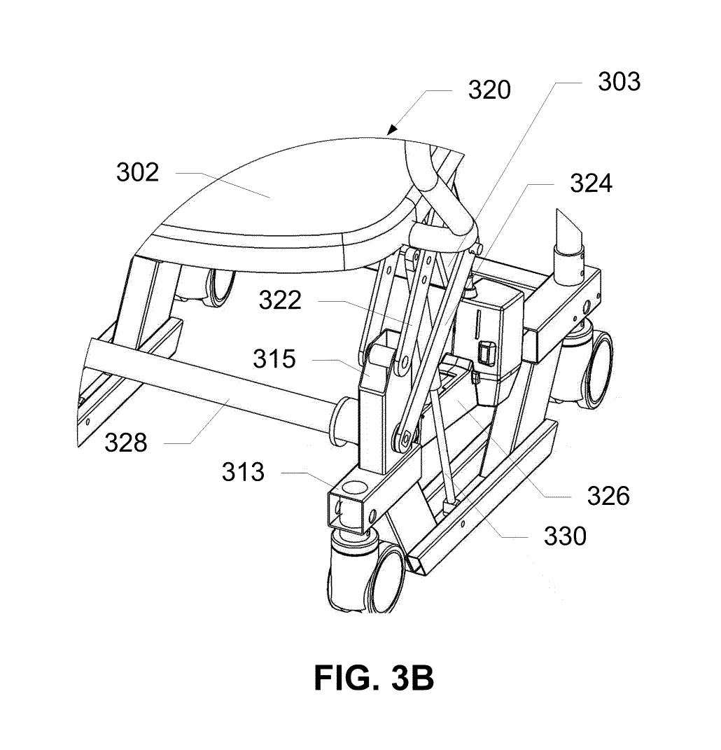

FIGS. 3A and 3B show a lifting mechanism 320 of a lift assist device 300, according to an exemplary embodiment of the present invention. In these figures, an outer portion of lifting mechanism 320 is viewed. FIG. 3A shows a lift assist device 300 having a lifting mechanism 320 that is exposed, i.e. there is no shroud covering lifting mechanism 320. FIG. 3B shows a detailed view of one side of lifting mechanism 320. Lifting mechanism 320 includes an upper linkage 322, a lower linkage 324, an actuator 326, a driveshaft 328, and a gas spring 330. Upper linkage 322 and lower linkage 324 have front ends that are pivotally coupled to connect a vertical support 315. Vertical support 315 is fixedly coupled to a front end of base member 313. Base member 313 is one of two base members that form base portion 104 of FIG. 1. The front end of lower linkage 324 is fixedly coupled to an end of driveshaft 328. This coupling includes but is not limited to a square end to drive shaft connected to a square receiving hole on the front end of second linkage 324. Upper linkage 322 optionally comprises a paired linkage, offering more horizontal stability. A rear end of each linkage 322, 324 is similarly pivotally coupled to a seat support 303 extending from a bottom surface of seat portion 302. Gas spring 330 is compressible, and is tuned to support seat portion 302 while allowing seat portion 302 to be raised and lowered in a smooth motion. A plurality of gas springs 330 provide an even pressure distribution on the bottom surface of seat portion 302. Gas spring 330 uses a compressed gas, contained in a cylinder and variably compressed by a piston, to exert a force. Although not shown in detail here, it should be understood that equivalent linkages, supports, springs, and optionally actuators are located on the opposite side of lift assist device 300, performing equivalent functions.

The pivotal coupling of each linkage to different heights on vertical support 315 and on seat support 303 causes seat portion 302 to angle forward as it is lifted. The lifting motion works as follows: Actuator 326 communicates with driveshaft 328 to transfer power to driveshaft 328. Actuator 326 converts electrical energy from a battery or power supply (not shown) into mechanical force, in this instance, pushing or pulling a rod in communication with driveshaft 328. This may be a hydraulic piston, a pneumatic actuator, electric motor, etc. As driveshaft 328 rotates, lower linkage 324, which is fixedly coupled at its front end to driveshaft 328, also rotates due to the force from actuator 326. As driveshaft 328 rotates about a horizontal axis, lower linkage 324 rotates about its front end, causing a lifting pressure to be applied to seat support 303. This causes the rear end of upper linkage 322 to lift as well. As this force rotates driveshaft 328, lower linkage 324 and upper linkage 322, gas spring 330 extends or compresses, as gas spring 330 is coupled to both seat portion 302 and base portion 304. As upper linkage 322 and lower linkage 324 lift at their rear ends, seat portion 302 is raised or lowered with respect to base portion 304. As linkages 322 and 324 are placed at different heights on seat support 303 and vertical support 315, seat portion 302 angles forward as it is lifted. The amount of tilt can be adjusted by changing the height at which linkages 322, 324 are pivotally coupled to seat support 303 and vertical support 315. Linkages 322 and 324 are constructed of a substantially strong and rigid material, such as metal, and are sized such that seat portion 302 may be raised and lowered to desired heights at desired angles, or for users of different dimensions. The force of gas spring 330 is used to support the weight of seat portion 302 and a user in seat portion 302. Gas spring 330 allows lift assist device 300 to work with substantially heavier users, as gas spring 330 takes much of the force off of the rest of lifting mechanism 320.

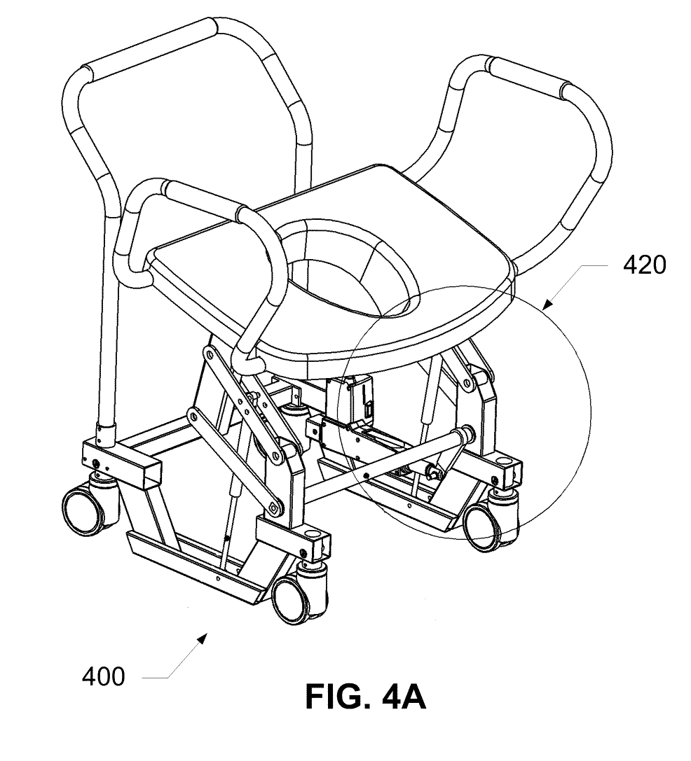

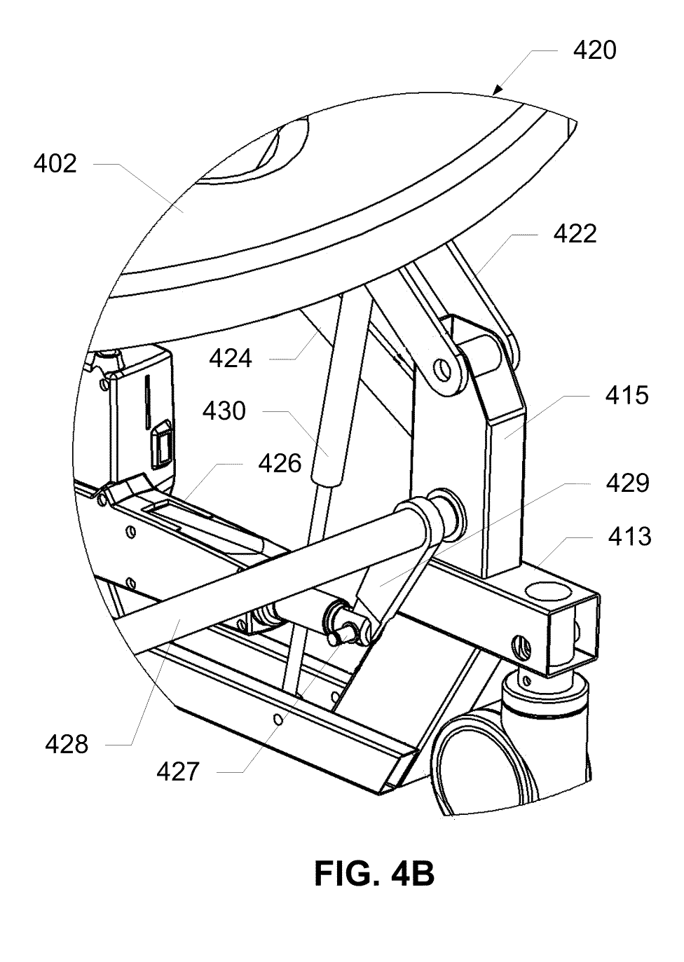

FIGS. 4A and 4B show a lifting mechanism 420 of a lift assist device 400, according to an exemplary embodiment of the present invention. FIG. 4A shows a lift assist device 400 having a lifting mechanism 420 that is exposed, i.e. there is no shroud covering lifting mechanism 420. FIG. 4B shows a detailed view of an inner side of lifting mechanism 420. A base member 413 comprises one of two base members of the base portion. Base member 413 includes vertical support 415, which has a provision to enable driveshaft 428 to fixedly couple with lower linkage 424. A distal end of an extendible portion 427 of actuator 426 is pivotally coupled to a lever 429 extending perpendicularly from driveshaft 428. The coupling may be accomplished by, for example, a pin between extendible portion 427 and lever 429, the pin allowing lever 429 to rotate about the coupling to the distal end of extendible portion 427. As lever 429 is pushed forward by actuator 426, driveshaft 428 rotates about its horizontal axis. The rotation of driveshaft 428 causes the rear end of lower linkage 424 to lift, applying upward pressure to the seat support underneath seat portion 402. Gas springs 430 provide even pressure across the bottom surface of seat portion 402, and assist lifting mechanism 420 to elevate a user in a controlled fashion.

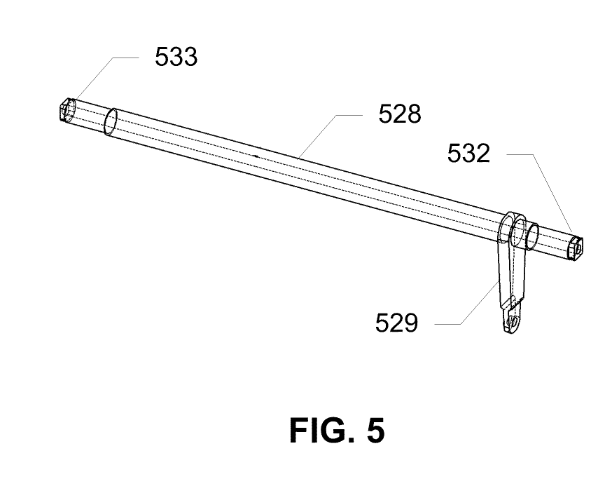

FIG. 5 shows a driveshaft 528 of a lift assist device, according to an exemplary embodiment of the present invention. Driveshaft 528 has at least two purposes: 1) to provide rotational energy to lift the linkages as described above and 2) to provide a coupling between the left and right base members that form the base portion. In this embodiment, driveshaft 528 includes a lever 529, a portion of which is pivotally coupled to a distal end of an extendible portion of an actuator. Further, right end 532 of driveshaft 528 fixedly couples to a front end of a lower linkage of the lifting mechanism via the means described above, such as a square end mated with a square receiving hole. Furthermore, left end 533 can optionally fixedly couple to a lower linkage on the left side of the lift-assist device, providing a more robust lifting mechanism. As force from the actuator pushes lever 529, driveshaft 528 rotates. Ends 532 and 533 of driveshaft 528 cause the second linkages to move about their front ends, thereby lifting a seat portion of the lift assist device as described above.

In further embodiments of the present invention, the driveshaft may include a lever near both ends of the driveshaft. Multiple levers allow the lift assist device to use multiple actuators for the lifting of the seat portion and user. This may allow for different sized actuators, such that two less powerful actuators may be used to raise an equivalent maximum weight, two similarly powerful actuators may raise more weight, etc.

FIG. 6 shows a wheel locking mechanism of a lift assist device, according to an exemplary embodiment of the present invention. Base member 613 is one of two (or more) base members that constitute a base portion of a lift-assist device. Base member 613 has wheels attached to it at a front and a rear end. At the front end is a wheel lock lever 640 having a shaft 642 and a brake 644. Shaft 642 is further coupled, via a protrusion, to rod 646. A twisting motion of lever 640 about shaft 642 will lock the wheel at the front end of base member 613. At the same time, the movement of rod 646 also causes a similar locking of the wheel at the rear end of base member 613. Consequently, a user can easily lock the wheels in place while loading, unloading, or whenever movement is unnecessary, simply by pushing or pulling lever 640 with their feet.

A second wheel locking mechanism can be included on the other side of the base portion (not shown). Alternatively, in a related embodiment, lever 640 is coupled to a plurality of rods 646 that enable a single lever to be used to lock all four wheels at both sides of the base portion. In embodiments without a rear stabilizer bar, it would necessary to lock both sides using separate mechanisms.

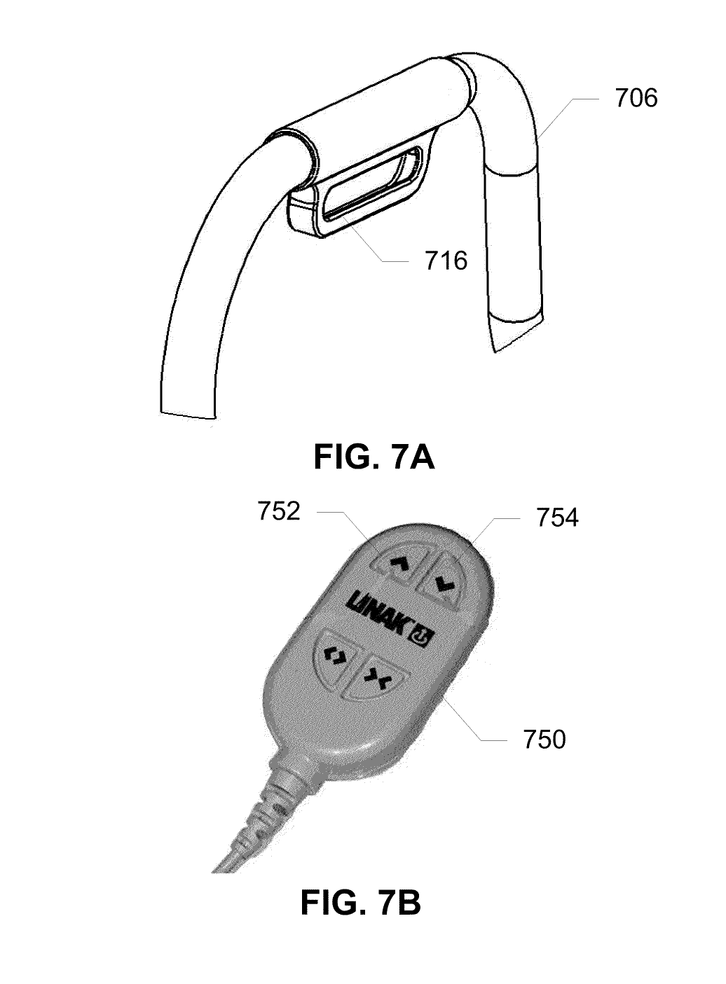

FIGS. 7A and 7B show controls for a lift assist device, according to an exemplary embodiment of the present invention. During motions as described with respect to the above figures, the seat portion may be elevated to various positions to ease the lifting and seating process for a user. Such lifting and seating processes may be controlled by the user through easily accessible buttons. As seen in the exemplary embodiment of FIG. 7A, these buttons are contained within controls 716 on handlebars of the lift assist device. This allows a user, a nurse, or a caretaker of the user of the lift-assist device to control the elevation of the seat portion. FIG. 7B shows controls attached to a corded control 750. Corded control 750 includes up button 752 and down button 754 to raise or lower the seat portion. Controls 716 and 750 include or communicate with a microcontroller having a processor and a memory, wherein the memory contains logic instructing the processor to control an actuator or motor. Controls may therefore include, besides raising and lowering, an option to adjust a speed, range, or generate an emergency alarm, etc. For instance, the controls can stop the motion at different points in the lifting motion, allowing a user to be lowered to 85% of the way to a seated position, or at varying increments for patients undergoing rehabilitation, based on their daily improvements. Further, the memory can include an option to store presets for different users of different dimensions, such that the lift assist device can be used by multiple users. In such a case, controls 716 and 750 could also include a preset selector. The exemplary device may be equipped with such large and clearly labeled buttons for readability, accessibility, instruction and safety. In one embodiment, an override control is provided on the push handle, giving a caregiver the ability to disengage the patient's controller. In another embodiment, the alarm generates a beacon that can be transmitted wirelessly to a monitoring station, for instance, a nurse's station at night, such that a user can request assistance of a nurse in an emergency situation or the nurse is notified that the lift assist device is in use.

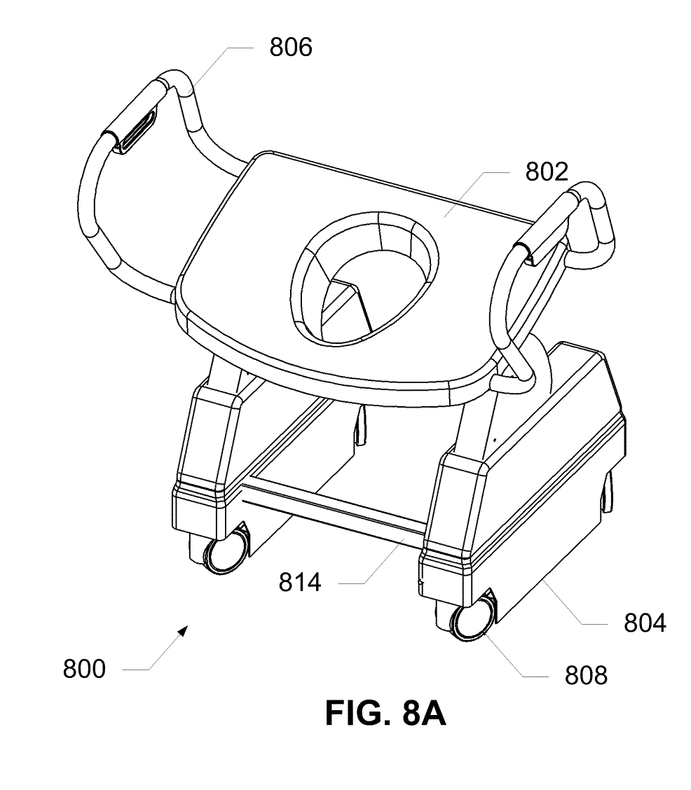

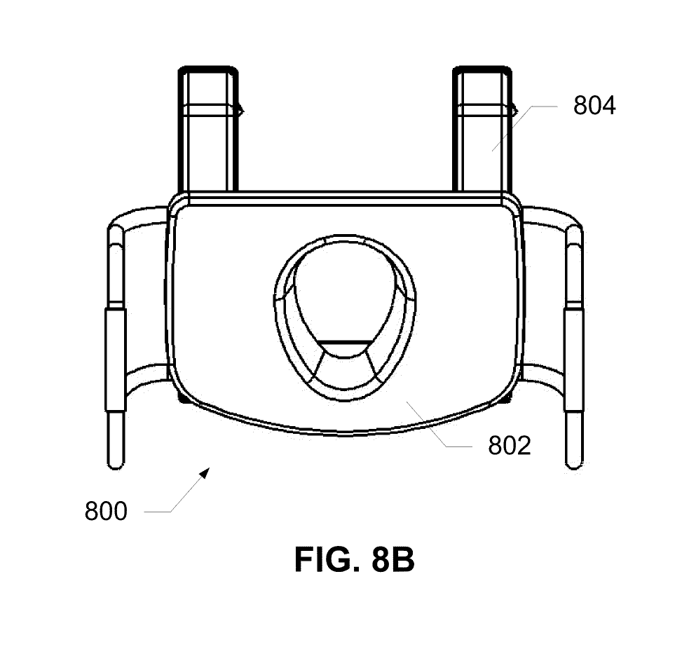

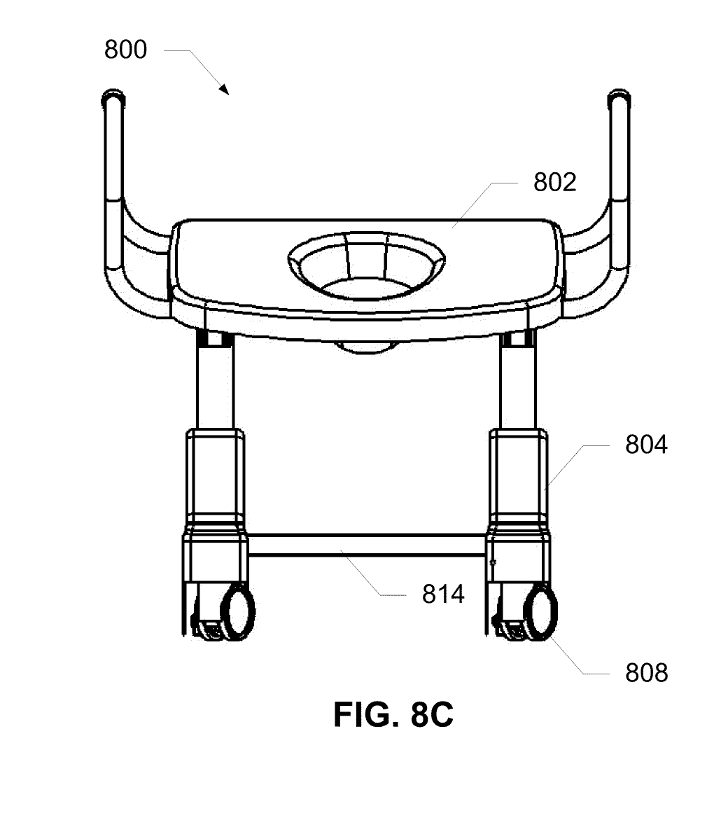

FIGS. 8A-8C show a lift assist device 800 for lifting a user over a toilet, according to an exemplary embodiment of the present invention. According to this embodiment, lift assist device 800 does not have a rear stabilizer bar and does not include a push bar, or has rear stabilizer bars and push bars that are removable. In this embodiment, lift assist device 800 includes a seat portion 802, a base portion 804, handlebars 806, a front stabilizer bar 814, and wheels 808. The absence of the rear stabilizer bars and push bar provides clearance such that lift assist device 800 is able to be moved over a toilet. Controls on handlebar 806 allow a user to lower seat portion 802 of lift assist device 800 to directly above the bowl of the toilet. When the user is finished, the user controls lift assist device 800 to raise the user back to a substantially standing position. Wheels 808 allow lift assist device 800 to be easily removed from toilet area. Handlebars 806 assist the user into sitting and standing positions. Front stabilizer bar 814 surrounds a driveshaft and provides stability to lift assist device 800. The wheels 808 themselves are optional—related embodiments that sit permanently over the toilet need not have any wheels.

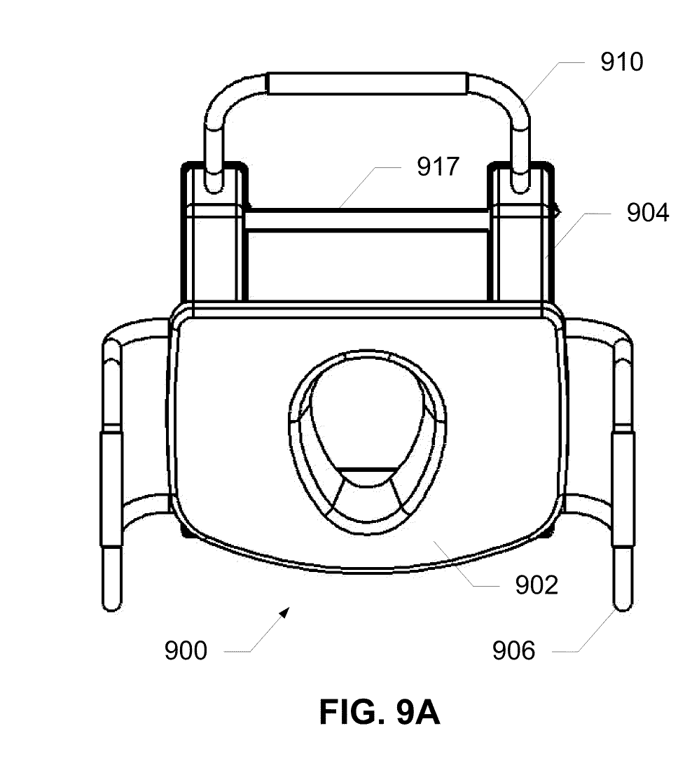

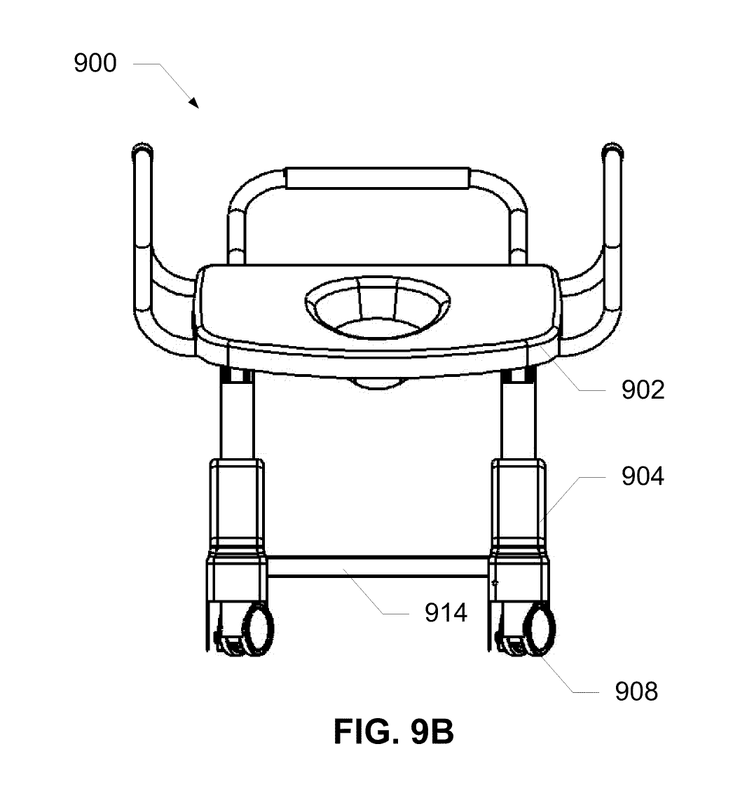

As described above, the present invention provides an adaptable device that can be used in a plurality of environments. FIGS. 9A and 9B show a lift assist device 900 for transporting a user, according to an exemplary embodiment of the present invention. In this embodiment, lift assist device 900 includes a seat portion 902, a base portion 904, handlebars 906, a push bar 910, a front stabilizer bar 914, and a rear stabilizer bar 917. Push bar 910 allows an assistant to easily roll the user on lift assist device 900 around an area. Front stabilizer bar 914 and rear stabilizer bar 917 provide structure and support to base portion 904 of lift assist device 900, and are respectively coupled to a left member of base portion 904 and a right member of base portion 904 such that lifting mechanisms on either side act in unison, and so that a user may be safely transported.

According to embodiments of the invention, the rear stabilizer bar may be disengaged and removed as necessary. This allows, for instance, the lift assist device to be moved above a toilet without the rear stabilizer bar impeding this placement. With the rear stabilizer bar moved or removed, the lift assist device may be rolled back to a location above the toilet. The rear stabilizer bar may completely detach, may rotate from one end, etc. in order to allow the lift assist device to roll backwards to encompass the toilet. Embodiments of the invention also allow for removal or rotation of the push bar to allow such placement. Further embodiments of the present invention allow for a height adjustment either in the wheels or in the seat portion, such that the lift assist device can be sized to fit different types of toilets. For instance, spacers can be coupled to the wheels to ensure that the lift assist device sits at the right height over the toilet.

FIG. 10 shows a toilet seat 1060 coupled to a seat portion 1002 of a lift assist device 1000, according to an exemplary embodiment of the present invention. In this embodiment, toilet seat 1060 may be flipped or placed over seat portion 1002, for instance, when lift assist device 1000 is placed over a toilet. When not being used above the toilet, toilet seat 1060 may be flipped back such that it hangs behind or under seat portion. Easy removal of toilet seat 1060 enables convenient cleaning and maintenance. Toilet seat 1060 may be made out of a material that is naturally anti-microbial, or treated with an anti-microbial treatment.

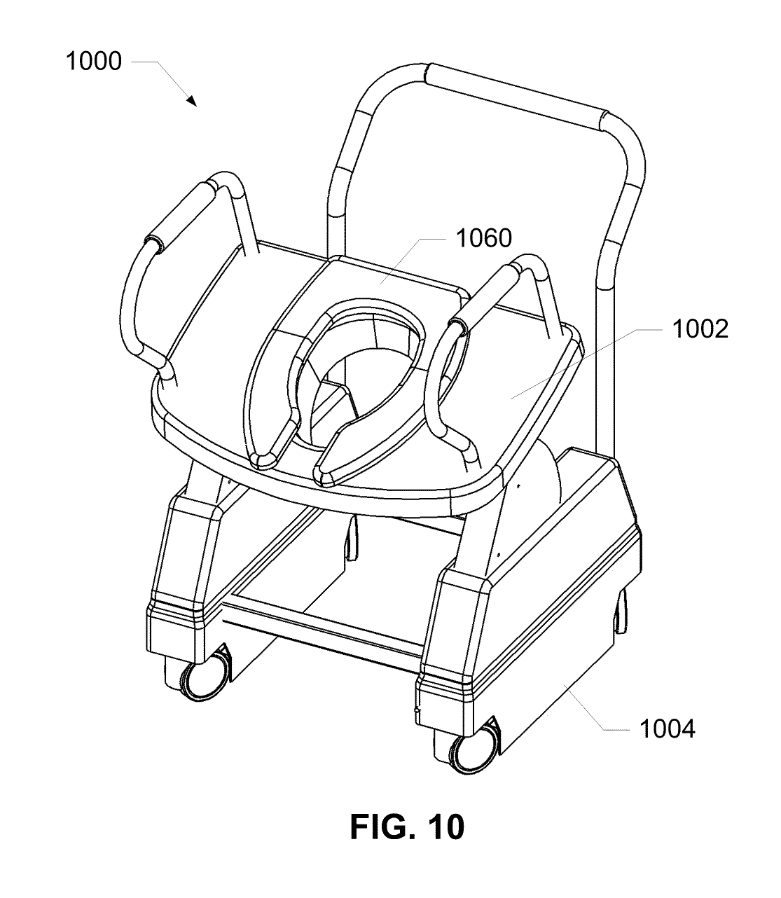

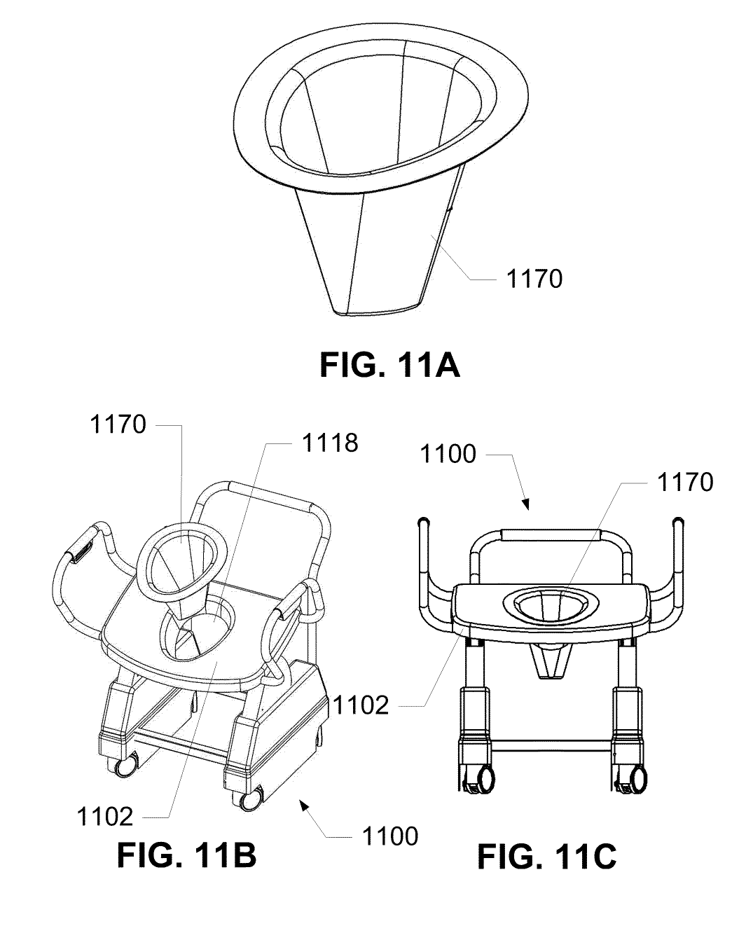

FIGS. 11A-11C show a drop-in commode bucket 1170 for use with a lift assist device 1100, according to an exemplary embodiment of the present invention. FIG. 11A shows the funnel-like shape of drop-in commode bucket 1170. Drop-in commode bucket 1170 may be formed of any material which is at least semi-rigid. For instance, plastic or rigid paper material may be used. Paper material may ideal in situations in which drop-in commode bucket 1170 is to be disposed of. Plastic material may be washed and reused. The shape of drop-in commode bucket 1170 allows waste to funnel into the bottom of drop-in commode bucket 1170. A ridge around drop-in commode bucket 1170 serves to secure drop-in commode bucket 1170 within a hole 1118 in a seat portion 1102 of lift assist device 1000, as shown in FIGS. 11B and 11C. The bottom of drop-in commode bucket 1170 may be cut out, such that drop-in commode bucket 1170 functions as a funnel, for instance, to funnel waste into a toilet below lift assist device 1100. Drop-in commode bucket 1170 may alternatively be formed into any shape, so long as drop-in commode bucket 1170 secures to seat portion 1102 of lift assist device 1100 in a position allowing waste to flow into drop-in commode bucket 1170.

Alternatively, the material may be a fabric/paper combination such that the entire drop-in commode and any potential collection within it are completely disposable in a toilet or other collection device. Alternatively, the bottom of the drop in commode bucket is closed to allow collection of the waste material therein. Alternatively, graded notches can be provided to allow for measurement of the volume of waste material. Related embodiments include a catheterization device coupled to the lift-assist device. Alternatively, the commode bucket can include ports to be connected to drainage systems such that emptying is not required and cleaning is only performed when necessary. Other embodiments include a urine guard for male users. Related embodiments include an LED or similar lighting mechanism to illuminate the toilet surface such that a user can operate the device at night without risk of falling.

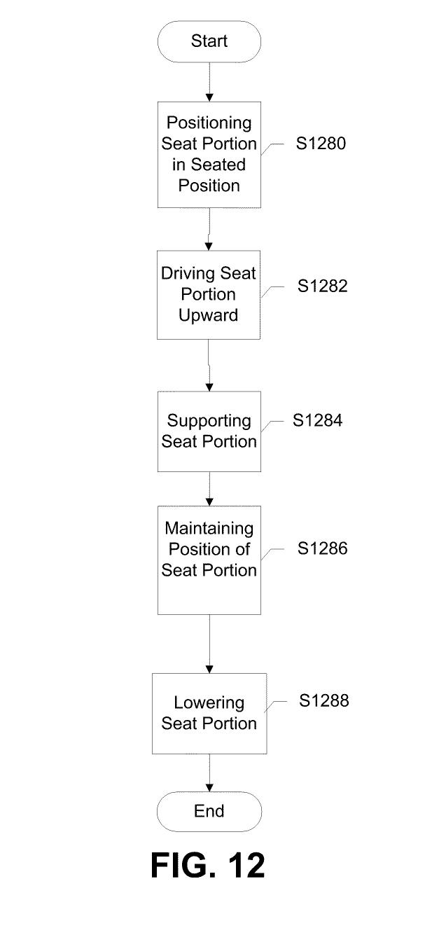

FIG. 12 shows a method of lifting a user from a substantially sitting position to a substantially standing position, according to an exemplary embodiment of the present invention. The method begins by positioning a user in a substantially sitting position on a lift assist device S1280. The controls of the lift assist device are manipulated to mechanically drive the seat portion substantially upward at a comfortable pace S1282. The seat portion is then supported evenly via a plurality of extendible springs pivotally coupled to the base portion and the seat portion S1284. The seat portion is then maintained, dynamically, at a critical angle to provide even support to the weight of the user and a leaning force of the user as the seat is driven upward until the user reaches a substantially standing position S1286. The maintaining step further comprises a first, lowered position that is substantially horizontal and a second, raised position that is relatively vertical with respect to the first position, so as to counteract a backward-leaning force of a user's torso. The user may then be lowered back down to a seated position by mechanically lowering the seat portion following the critical angle until the user reaches a substantially sitting position S1288.

The method may be utilized while the lift assist device is located over a toilet. The raising and lowering assist a user in sitting down above the toilet and being raised back to his or her feet. The method may further include removing a handlebar to enable a user to be transported from the device onto a bed.

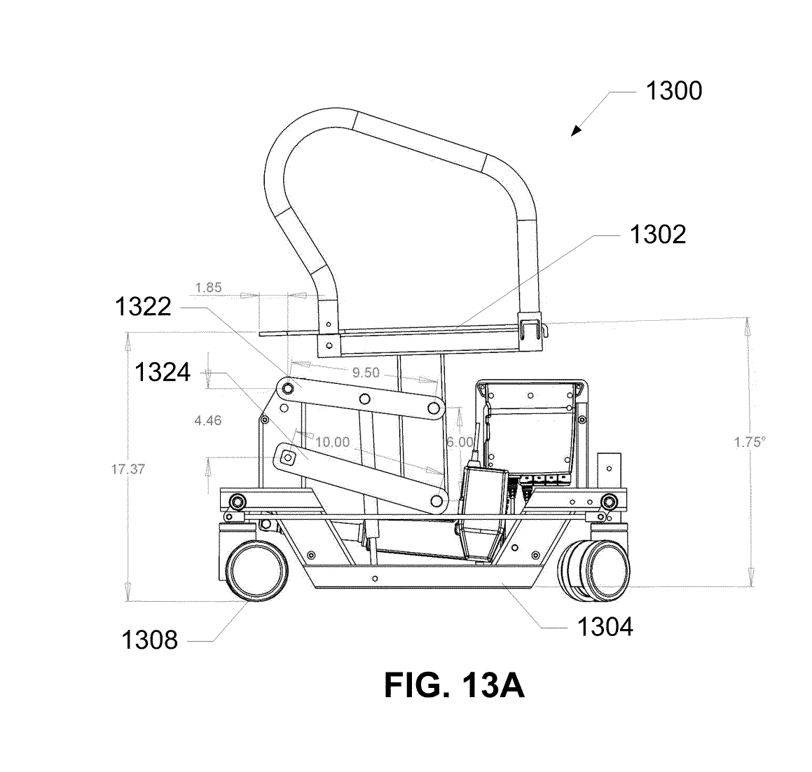

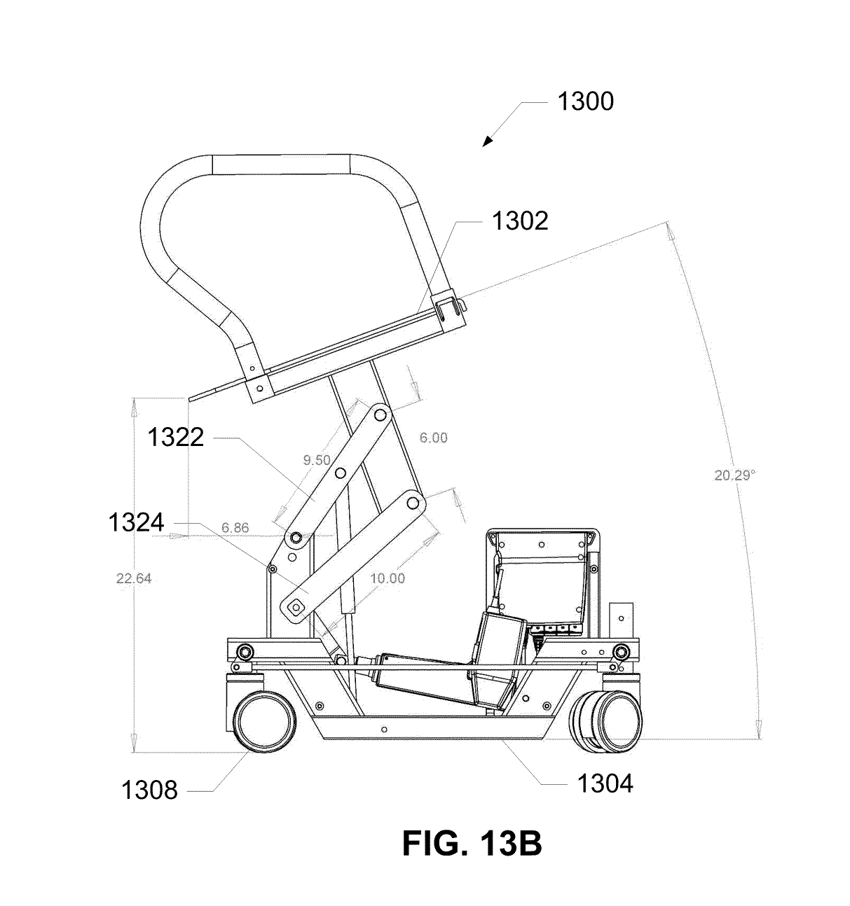

FIGS. 13A and 13B show the range of motion of a lift assist device, according to an exemplary embodiment of the present invention. FIG. 13A shows the approximate dimensions of lift assist device 1300 in a seated position. In this position, the front of seat portion 1302 is located approximately 17.37 inches above the bottom of wheel 1308 while the back of seat portion 1302 is located at an angle raised approximately 1.75 degrees above the horizontal level of the bottom of base portion 1304. The front end of upper linkage 1322 is pivotally coupled to a height on the vertical support on base portion 1304 approximately 4.46 inches above a height where the front end of lower linkage 1324 is similarly coupled. The rear end of upper linkage 1322 is pivotally coupled to a point on the seat support of seat portion 1302 approximately 6 inches above a point where the rear end of lower linkage 1324 is similarly coupled.

FIG. 13B shows the approximate dimensions of lift assist device 1300 in a raised position. In this position, the front of seat portion 1302 is located approximately 22.64 inches above the bottom of wheel 1308 while the surface of seat portion 1302 is tilted at approximately 20.29 degrees above the horizontal level of the bottom of base portion 1304. It should be understood that these dimensions are approximate, and that the invention is not limited to this specific embodiment or to the scale of the drawings shown.

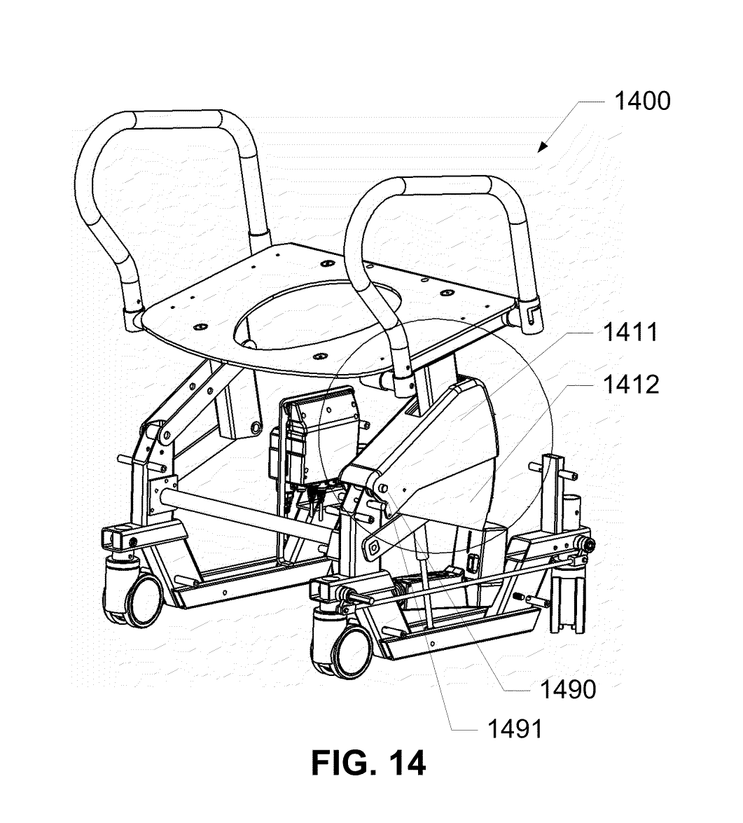

FIG. 14 shows a telescoping shroud for the linkages of a lift assist device, according to an exemplary embodiment of the present invention. According to this embodiment, a secondary shroud 1411 extends above a shroud 1412. The telescoping shroud system automatically expands and contracts by the lifting and lowering of the lifting mechanism of lift assist device 1400. Shroud 1412 is formed such that it allows secondary shroud 1411 to rotationally rise, with a rod 1490 attached to secondary shroud 1411. A lower stop 1491 on shroud 1412 prevents both shrouds, 1411 and 1412, from traveling too far. Not shown are the additional shrouds covering the base portion, for the sake of clarity.

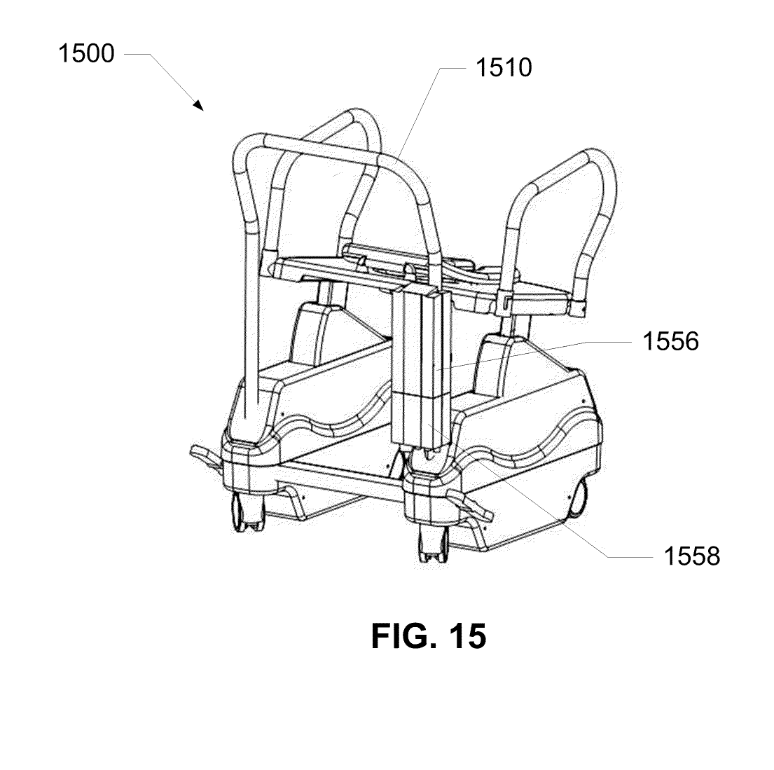

FIG. 15 shows a battery and control box location on a lift assist device, according to an exemplary embodiment of the present invention. In this embodiment, lift device 1500 has a push bar 1510 that comprises a horizontal portion supported by two vertical portions that attach to a base portion of lift assist device 1500. Coupled to one vertical portion of push bar 1510 is a battery 1556, and a control box 1558. Battery 1556 provides power to control box 1558, actuators (not shown), and other electronic components of lift assist device 1500. Control box 1558 includes components necessary to control any combination of actuators, motors, pistons, etc. that enable lift assist device 1500 to lift a user. For instance, control box 1558 includes a microcontroller, memory, and an interface to connect to an input device such as the controls described above with respect to FIG. 7. It should be understood that the placement of battery 1556 and control box 1558 is merely exemplary, and that these features can be placed on either side of lift assist device 1500, hidden within the shroud, etc.

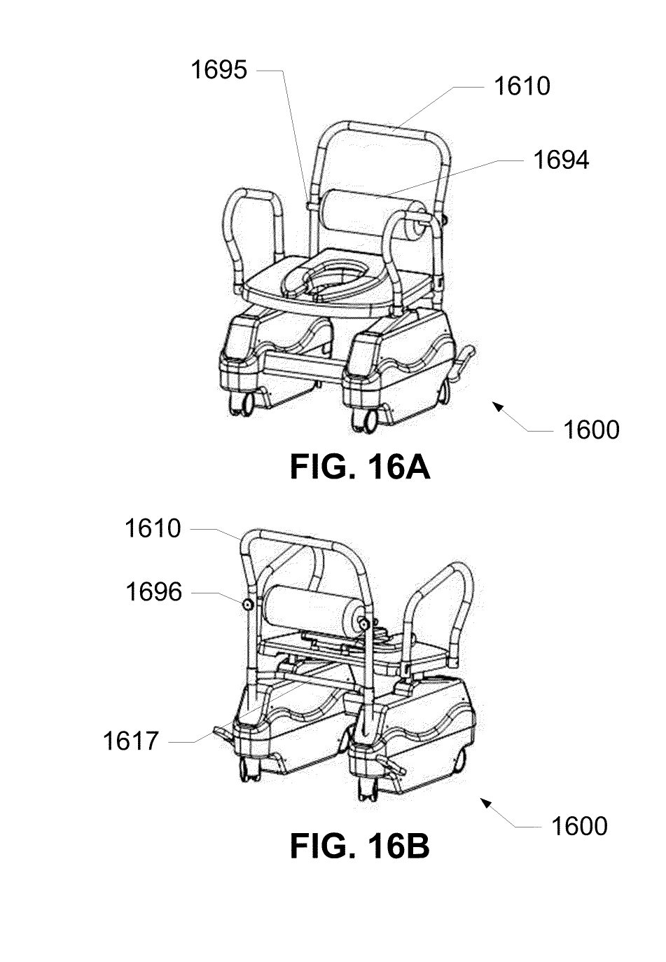

FIGS. 16A and 16B show views of a lift assist device having a back rest and adjustable rear stabilizer bar, according to an exemplary embodiment of the present invention. FIG. 16A shows a front view of lift assist device 1600, including a push bar 1610 comprising a horizontal portion supported by two vertical portions, as described with respect to FIG. 15. Further, back rest 1694 is supported by a back rest shaft 1695 that rotationally couples to the vertical portions of push bar 1610. Back rest 1694 can be padded, and flexible, so as to conform to the lateral curvature of different users' backs. Further, the ability to rotate around shaft 1695 provides a comfortable level of movement for users.

FIG. 16B shows a rear view of lift assist device 1600. Here one can see that back support shaft 1695 is coupled to push bar 1610 via a pair of removable screws 1696. Besides being used to completely remove back support 1694, screws 1696 provide an adjustment capability, allowing a user to adjust a height of back support 1694. Further, a rear stabilizer bar 1617 is coupled to the vertical supports of push handle 1610. Rear stabilizer bar 1617 provides additional structural stability to lift device 1600, especially when used as a transportation device for patients with mobility issues.

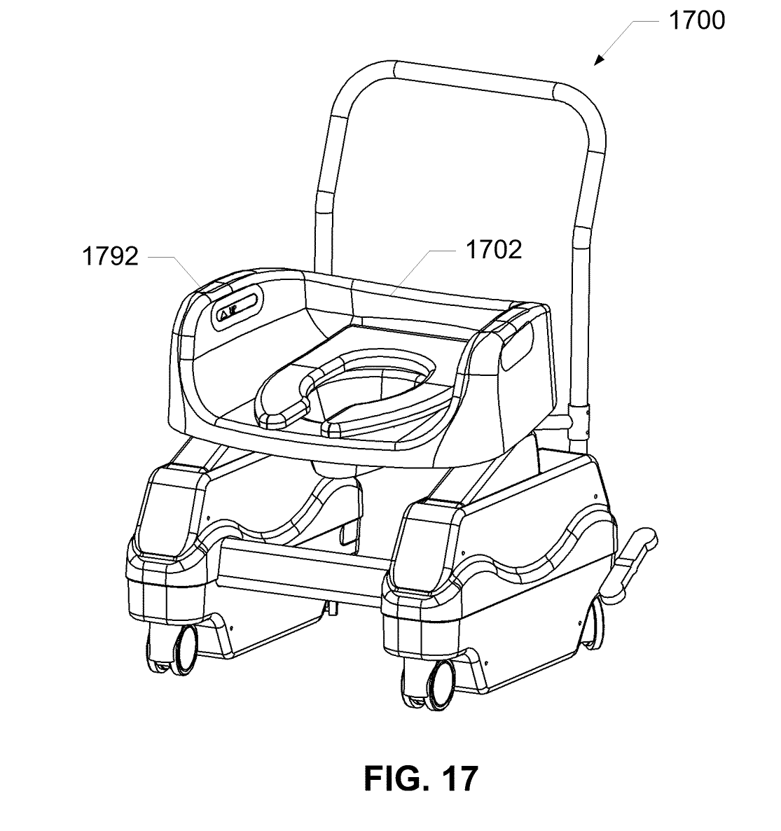

FIG. 17 shows a bedside lift assist device with a contoured seat portion, according to an exemplary embodiment of the present invention. According to this embodiment, the handlebars of other embodiments are replaced with contoured seat portion 1702. Contoured seat portion 1702 curves up around where a user sits. Contoured seat portion 1702 includes handles 1792 which may be grasped by the user, similarly to the handlebars. Controls may be located within handles 1792 or elsewhere on lift assist device 1700. Contour seat portion 1702 may be formed from a single material or the multiple materials disclosed above, including padding, liners, flexible portions, etc. Contour seat portion 1702 can further be removed and replaced with other types of seat portions discussed in this disclosure. Therefore, the present invention provides a standard base portion and lifting mechanism that can be coupled to a variety of non-standard seat portions that are designed for different purposes.

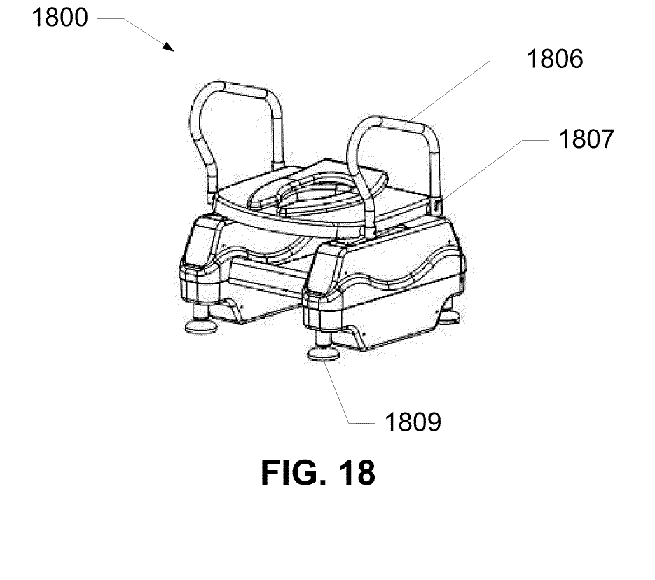

FIG. 18 shows a height-adjustable over-the-toilet lift assist device with removable handlebars, according to an exemplary embodiment of the present invention. In this embodiment, lift assist device 1800 includes handlebars 1806 that are removable via slotted groove 1807. A push-pin release may be incorporated to lock handlebars 1806 in place. Further, lift assist device 1800 includes height-adjustable feet 1809 instead of the wheels described above. This provides stability for lift assist devices that are meant to be placed over toilets for extended periods of time and need not be moved. Height-adjustable feet 1809 may include suction cups, drill holes to enable coupling with floors, etc. Further, the height-adjustment mechanism enables precise leveling of lift assist device 1800, as well as the ability to customize the height for multiple toilet types. Height-adjustment mechanism can include a screw-based adjustment, the use of spacers, etc.

The exemplary embodiments of the present invention described above, as well as any further conceivable versions, are all designed to be rigid in frame and stable to prevent undesired movement of the device during the lifting or lowering motion. This can be achieved by lowering a center of gravity, building a wider base portion relative to a seat portion, etc. The center of gravity can be lowered by appropriate placement of heavier components such as batteries, actuators, motors, etc. This decreases the chances for injuries that may occur as a result of the loss of stability of the device. Further, the motion of the lifting mechanism is designed to be smooth, effortless, and reflective of the natural ergonomic motion of the body, so as to decrease the risks of injury to the body that are possible during an unnatural or jerky motion, as is common in conventional devices. This is achieved by a combination of actuators, linkages, and compressible springs that connect the base portion to the seat portion. Moreover, various combinations of shrouds can be used as protective walls that can serve to protect the arms, legs, and other appendages of a user from any contact with moving parts of the device. The shrouds and covers also help easy cleaning of the device, such as being hosed or wiped down, without concern for disturbing or moving any critical components.

The use of the present device has been described with respect to a user in general. As briefly described above, such user may be elderly, handicapped, or otherwise incapacitated. However, the present invention is not limited to such persons but can be used by anyone who desires assistance in movement from one position to another. For example, an obese individual may have significant difficulty in standing up from a laying or sitting position, but has little trouble walking once standing. The use of this device assists the obese individual in standing without aid from another individual. Besides moving from a seated position to a raised position, the present invention has the potential to be used to assist persons to move from a substantially horizontal position (e.g., lying down or supine) to a sitting and/or standing position, and vice versa. In general, the present invention may be used to assist a person in any relative movement from a portion or all of the body being in a substantially horizontal to a substantially inclined or vertical position, and vice versa. Other changes in body position assistance are also possible through the present invention. Thus, use of the present invention results in both cost savings (obese individual can stand and sit without aid worker, no potential injury to aid worker, etc.) and preservation of dignity and sense of autonomy for the user. These advantages are applicable to other users of the device as well, other than obese individuals.

The present invention is not only limited to persons who are permanently weakened, diseased or physically affected. For example, the present invention may also be used by individuals who have temporary injuries or conditions, such as persons with sport or accidental injuries that cause difficulty moving or standing. Also, persons using crutches have difficulty standing and sitting and can also benefit from the present invention. Another class of individuals who can greatly benefit from assistance in standing and sitting include pregnant women, who often have difficulty in such otherwise routine motions. The adjustable features of the present invention, including adjustable controls, allow a person's performance to improve during the rehabilitation process, enabling dynamic physical therapy and recovery.

Thus, because so many different types of people with different conditions, limitations or needs can benefit greatly from the use of the present invention, lifting devices according to the present invention may be incorporated virtually anywhere where such motion can potentially occur, including the home, businesses, motorized vehicles and the like. The above embodiments discuss the lift-assist device being used over a standard toilet and anchored in place so as to minimize any unwanted movement of the device during the lifting motion. In this application, the lifting device can serve to lift and lower toilet seat to aid a user who cannot perform these motions without assistance. When the lifting device is installed on a toilet it is important to note that this and many other embodiments of the lifting device do not depend on the toilet for support. The embodiment is free standing and has enough strength to support itself and a person sitting on top. As such, installation of the lifting device is not permanent, and can be relocated.

The lift device according to the present invention can also be incorporated in many other environments with slight changes in the shape of the components; such slight changes are those as would be known to one having ordinary skill in the art. Examples include vehicle seats, seats in the home (chairs, couches, sofas, beds, toilets, showers, etc.), seats in business environments (physician offices, examination rooms, waiting areas, stadiums, arenas, theaters, restaurants, airplanes, buses, etc.) and anywhere else where such a device would be beneficial, such places become more apparent to one having ordinary skill in the art in light of the above disclosure. Changes in shape and components are anticipated within the present invention and all such changes are within the scope of the present invention. Such changes can include a movable back rest support, detachable seats, padded seats, adjustable and removable handlebars and push bars, and the ability to meet specific requirements such as those of the American Disabilities Act (ADA). Changes can also be made to meet different weight requirements of different users, such as a larger weight requirement for users with bariatric problems, etc.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A lift-assist device, comprising:
a horizontal base portion including a pair of base members extending from a rear end to a front end of the device;
a substantially vertical support extending perpendicularly from a top surface of each base member;
a drive shaft coupled to and placed in between each vertical support;
a lifting mechanism including a pair of upper linkages and a pair of lower linkages, each linkage having a front end and a rear end, the front end of each pair of linkages being pivotally coupled to each substantially vertical support, the front end of the pair of lower linkages further being fixedly coupled to each end of the driveshaft; and
a substantially planar seat portion including a pair of seat supports extending perpendicular to a bottom surface of the seat portion, each seat support being pivotally coupled to a rear end of each upper and a lower linkage,
wherein a rotational movement about a horizontal axis of the driveshaft raises the rear end of the pair of lower linkages, thereby moving the seat portion from a sitting position to a raised position.

2. The device of claim 1, wherein the pair of upper linkages is pivotally coupled to each seat support at a point higher than a point where the pair of lower linkages pivotally couples to the seat support, such that the seated position of the seat portion is substantially horizontal with respect to the raised position.

3. The device of claim 1, further comprising an actuator to provide rotational energy to the driveshaft.

4. The device of claim 3, further comprising a lever extending perpendicularly from the drive shaft, a distal end of the lever being pivotally coupled to an extendible portion of the actuator, wherein an extension of the extendible portion causes a rotation of the driveshaft.

5. The device of claim 1, further comprising a compressible spring extending from each base member to each upper linkage, the compressible spring being pivotally coupled to the base member and the upper linkage.

6. The device of claim 1, wherein the seat portion has a hole placed in a middle of the seat portion, such that the device can be placed over a toilet seat.

7. The device of claim 1, further comprising a bucket that is removably attached to an edge of the hole in the seat portion, such that the device can be used as a toilet seat.

8. The device of claim 1, further comprising a pair of adjustable handlebars removably coupled to a left and right side of the seat portion.

9. The device of claim 1, further comprising a plurality of wheels coupled to the front and rear ends of each base member, the wheels enabling the device to be moved around, and a plurality of wheel locks.

10. The device of claim 1, further comprising a plurality of shrouds covering the base members, vertical supports, driveshaft, linkages, and seat supports.

11. The device of claim 1, further comprising a microcontroller coupled to the actuator, and a control panel to control the microcontroller, wherein a battery powers the microcontroller and the actuator.

12. A human lifting device comprising:
a base portion;
a pair of vertical supports fixedly coupled to a left and a right side of the base portion;
a plurality of linkages pivotally coupled to each vertical support at a front end of the plurality of linkages;
a seat portion having a pair of seat supports extending from a bottom surface of the seat portion, each seat support being pivotally coupled to a rear end of the plurality of linkages coupled to the corresponding vertical support;
a plurality of compressible springs pivotally coupled to the base portion and the plurality of linkages; and
a lifting mechanism comprising an actuator coupled to the base portion that, upon activation, lifts the seat portion from a seated position that is substantially planar to a raised position that is substantially angled relative to the seated position.

13. The device in claim 12, wherein the front ends of the plurality of linkages are coupled to different heights on the vertical support and on the seat support, so as to control the angle of the seat portion from the seated position to the raised position.

14. The device of claim 12, further comprising a drive shaft coupled to and placed in between each vertical support, said driveshaft being fixedly coupled to a front end of at least one of the plurality of linkages such that a rotational movement of the driveshaft moves the seated portion from a seated position to a raised position, wherein the actuator provides rotational energy to the driveshaft.

15. The device of claim 12, further comprising a plurality of shrouds covering the base members, vertical supports, linkages, and seat supports.

16. The device of claim 12, further comprising a pair of adjustable handlebars removably coupled to a left and right side of the seat portion.

17. A method for lifting a user from a substantially sitting position to a substantially standing position, the method comprising:
positioning the user in a substantially sitting position on a device having a planar seat portion, a lifting mechanism, and a base portion;
mechanically driving the seat portion substantially upward at a comfortable pace;
supporting the seat portion evenly via a plurality of extendible springs pivotally coupled to the base portion and the seat portion;
maintaining, dynamically, the seat portion at a critical angle to provide even support to a weight of the user and a leaning force of the user as the seat is driven upward until the user reaches a substantially standing position; and
mechanically lowering the seat portion following the critical angle until the user reaches a substantially sitting position.

18. The method of claim 17, wherein the maintaining step further comprises maintaining the seat portion at a seated angle that is substantially horizontal, and a lifted angle that is substantially horizontal, so as to counteract a leaning force of a user.

19. The method of claim 17, further comprising placing the device over a toilet seat.

20. The method of claim 17, further comprising removing a handlebar to enable a user to be transported from the device onto a bed.
